(19) United States
(12) Patent Application Publication
(10) Pub. No.: US 2013/0079079 A1
(43) Pub. Date: Mar. 28, 2013

(54) DIGITAL JIGSAW PUZZLE GAME FOR MOBILE DEVICE PLATFORMS

(71) Applicants: David Bouchard, Notre-Dame-De-L'lle-Perrot (CA); Richard Latreille, Mont-Laurier (CA)

(72) Inventors: David Bouchard, Notre-Dame-De-L'lle-Perrot (CA); Richard Latreille, Mont-Laurier (CA)

(21) Appl. No.: 13/623,870

(22) Filed: Sep. 20, 2012

Related U.S. Application Data
(60) Provisional application No. 61/537,167, filed on Sep. 21, 2011.

(51) Int. Cl. A63F 13/00

(52) U.S. Cl. CPC A63F 13/005
USPC 463/9

(57) ABSTRACT

A system and method of providing a digital jigsaw puzzle game for mobile device is disclosed that comprises a computer physic simulation in which puzzle pieces are placed over a tilted surface displaying the picture of a puzzle. The tilted surface position and orientation within the 3D space of the simulation are driven by the motion sensors inputs of the mobile device. Each puzzle pieces are subject to gravity so that, as the user tilts the mobile device in a certain direction, the surface is tilted and the pieces slide down the surface in the corresponding direction. The motion of each puzzle pieces is computed using Newton's law of motion based on all external forces applied on each one. A puzzle piece moving close to its final position will be automatically placed and locked there. As a result of the above-mentioned, as the user moves the mobile device, he controls the motions of the pieces over the picture displayed on the mobile device screen in order to complete the puzzle.

### CROSS-REFERENCE TO RELATED APPLICATIONS

This application claims the benefit of U.S. Provisional Application No. 61/537,167 entitled “DIGITAL JIGSAW PUZZLE GAME FOR MOBILE DEVICE PLATFORMS”, filed Sep. 21, 2011, and is hereby incorporated by reference.

### TECHNICAL FIELD

The present invention relates to a jigsaw puzzle game. More particularly, the present relates to a digital jigsaw puzzle game for mobile devices that involves the physical model simulation of a slippery surface gameboard.

### BACKGROUND

Parents and educators know that jigsaw puzzles have been a long time favorite learning tool for kids. They enhance their early childhood education both at home and at school. Jigsaw puzzle will improve a child's problem solving, reasoning skills and are also a fun way to improve fine motor skills. Puzzles can be done alone or in a group setting to foster cooperative play or even to encourage family time at home. Jigsaw puzzle play is a key factor in a child's development. This is especially true with kids suffering from autism and from similar developmental disorders. Occupational therapist and other specialists who provide for them have known this for a long time now.

In recent years, a few digital jigsaw puzzle games for mobile devices were introduced on the market. They are usually digital equivalent of the traditional jigsaw puzzle where a player can move a puzzle piece by moving his finger over the touchscreen of the mobile device. The problem associated with those existing digital jigsaw puzzle games is they do not take advantage of the full possibilities available on the latest mobile devices such as the Apple iPhone® or the iPad®. They do not use the motion sensing capabilities, which enable the player to interact with the game by moving and rotating the mobile device in three-dimensional space.

Autistic kids need tools to develop coordination with their body's movements, to better manage their body in space and help to improve sensory integration (i.e. help with processing information through the senses). There is a need for a digital jigsaw puzzle game that could help improve those skills through 3D motion while still offering all the educational and fun added values of traditional jigsaw puzzles. A digital puzzle game that could not have been invented before the introduction of the iPad® and of all the other mobile devices equipped with such motion sensing capabilities and a big screen.

### SUMMARY

According to embodiments of the invention, a digital puzzle game for mobile device is provided that includes a physic simulation where a plurality of puzzle pieces is placed over a tilted slippery surface. The puzzle pieces are subject to the force of gravity and obey to Newton's laws of motion so that they can slide on that slippery surface. The slippery surface position and orientation in 3D space is driven by the motion sensors of the mobile device in such a way that a player moving the mobile device will position the surface and thus consequently lead the motion of the puzzle pieces in the direction he wants to as they slide down. In other words, keeping the mobile device screen perfectly still and horizontal relatively to gravity will induce very little or no motion of the puzzle pieces, while moving and rotating the mobile device away from that position will induce puzzle movements in accordance to Newton's laws of motion running within the physic simulation.

In some embodiments, the slippery surface may display a reference picture of the completed jigsaw puzzle so that a player can figure out where to position the puzzle pieces in order to finish the puzzle. Once a puzzle piece is positioned and oriented close to its own final position, the puzzle piece may be locked in place at its exact final position. In the same way as traditional jigsaw puzzles, the puzzle is completed once all puzzle pieces are locked into their own and unique final position.

In some embodiments, the player may also use the touchscreen interface to move the puzzle piece in addition to what has been described previously. Touching a puzzle piece with the tip of the finger enables this piece to be moved in a similar manner as what is happening in real life. That is to say, as when moving a similar cardboard jigsaw puzzle piece with the tip of the finger on a table in reality.

In some embodiments, the player may select before starting the puzzle game which picture he wants the puzzle to be generated from. This picture may be selected from various sources. Additionally the player may select other types of puzzle shape, which are different from the traditional jigsaw puzzle shape that everyone is familiar with. He may also select the number of pieces contained in the whole puzzle to be generated.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The features of the invention will be better understood by reference to the accompanying drawings which illustrate presently preferred embodiments of the invention.

FIG. 1A shows a perspective view of the puzzle game where it is being played on both an iPad® and on an iPhone®, according to embodiments of the present invention.

FIG. 1B shows a front view of the slippery surface displayed on the mobile device screen, according to embodiments of the present invention.

FIG. 2A illustrates the representation of the simulated physical model where the slippery surface is perpendicular to gravity, according to embodiments of the present invention.

FIG. 2B illustrates the representation of the simulated physical model where the slippery surface is not perpendicular to gravity, according to embodiments of the present invention.

FIG. 2C illustrates the representation of the simulated physical model where the slippery surface is moved along the x axis relatively to gravity without any rotation, according to embodiments of the present invention.

FIG. 2D illustrates the viewpoint fixed relatively to the slippery surface for different positions and orientations of the slippery surface.

FIG. 3 is a flowchart illustrating a method of providing a jigsaw puzzle game, according to embodiments of the present invention.

FIG. 4 shows different puzzle shapes, according to embodiments of the present invention.

FIG. 5A illustrates the diagram of a typical mobile device or handheld device, according to embodiments of the present invention.

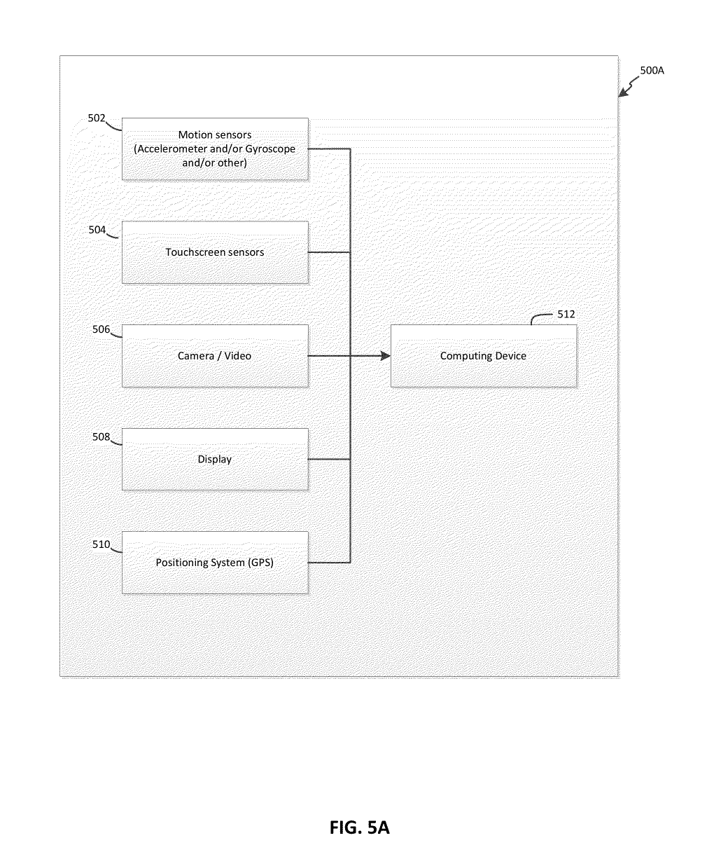

FIG. 5B illustrates the diagram of a computing device, according to embodiments of the present invention.

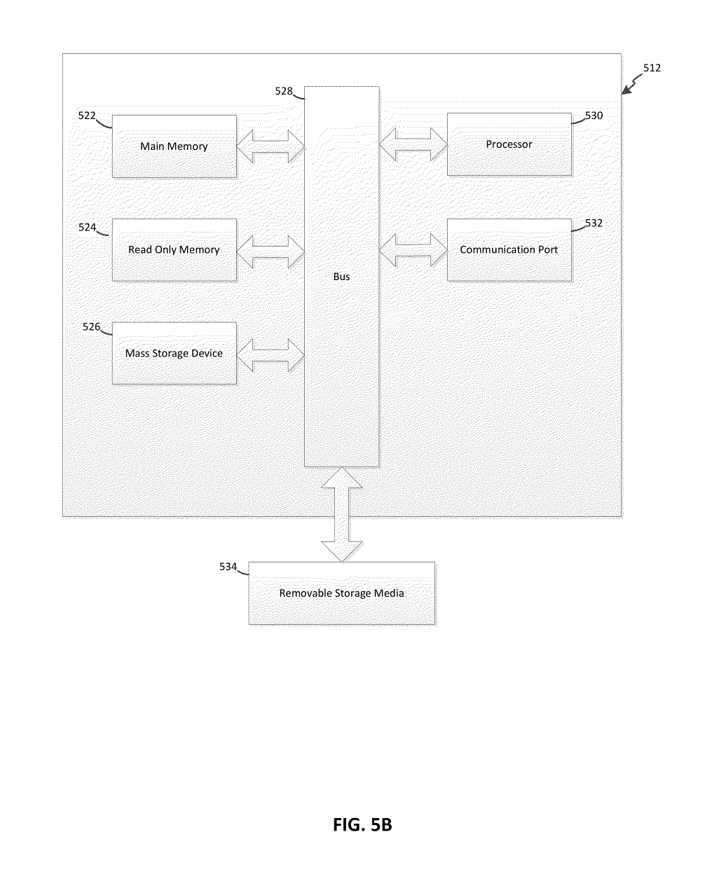

While the invention is amenable to various modifications and alternative forms, specific embodiments have been shown by way of example in the drawing and are described in detail bellow. The intention, however, is not to limit the invention to the particular embodiments described. On the contrary, the invention is intended to cover all modifications, equivalents, and alternatives falling within the scope of the invention.

### DETAILED DESCRIPTION

Embodiments of the digital jigsaw puzzle game will now be described with references to the accompanying figures, wherein like numerals represent corresponding parts of the figures. The terminology used in the description presented herein is not intended to be interpreted in any limited or restrictive manner, simply because it is being utilized in conjunction with a detailed description of certain specific embodiments of the invention. Furthermore, embodiments of the digital jigsaw puzzle game may include several novel features, no single one of which is solely responsible for its desirable attributes or which is essential to practicing the inventions herein described.

Embodiments of the present invention include a digital jigsaw puzzle game for mobile devices. In some embodiments, game play involves one or more players to complete a puzzle by positioning the puzzle pieces. In order to move the puzzle pieces, the player has to move and rotate the mobile device in three-dimensional space. This process will be described in great detail later in the text.

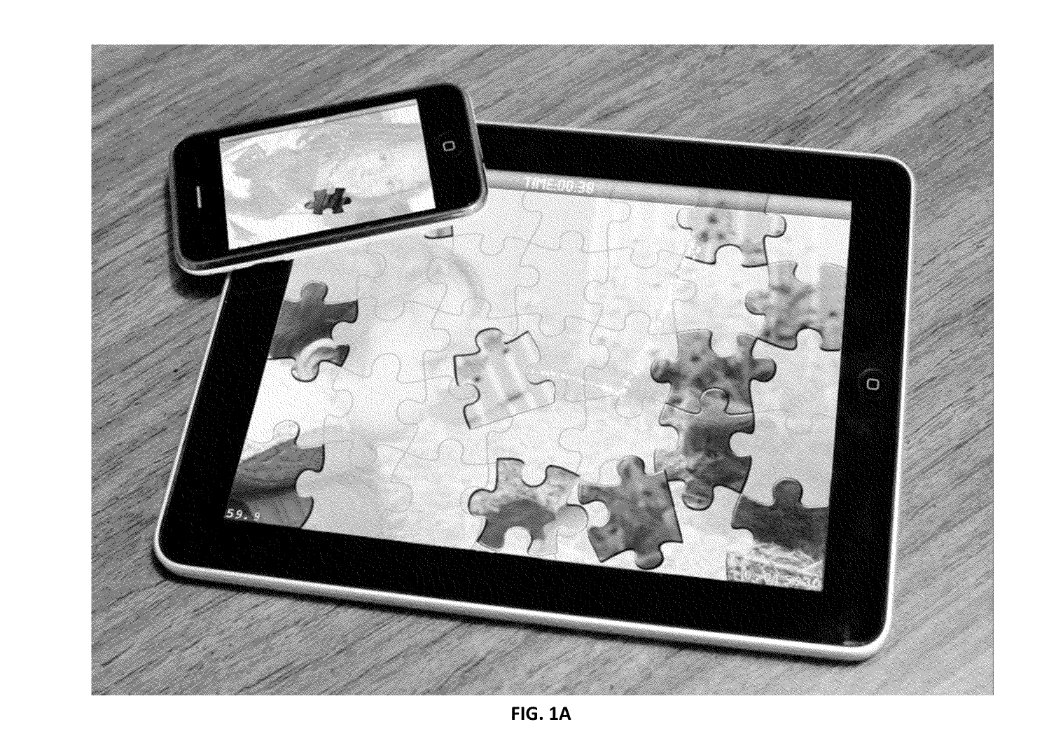

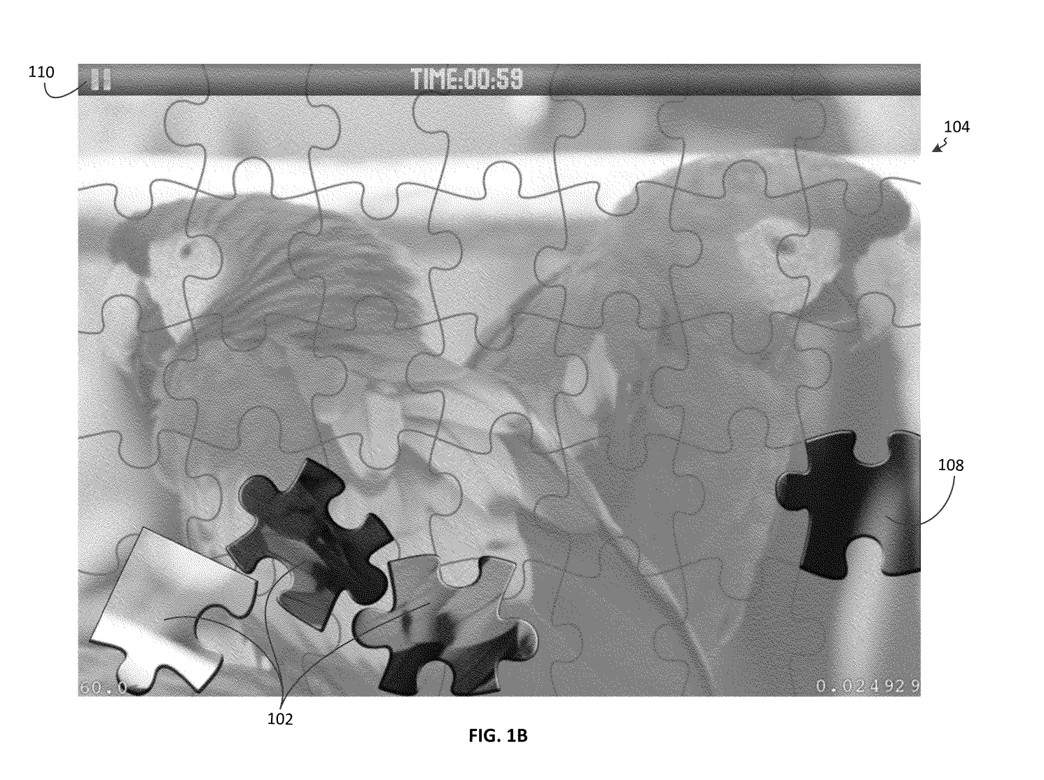

Referring now to FIGS. 1A and 1B, one can see perspective views of mobile devices running the digital jigsaw puzzle game according to preferred embodiments of the invention. In this game, the puzzle pieces 102 are free to slide on a slippery surface 104 which may display a reference picture of the whole puzzle to be completed. As for traditional cardboard jigsaw puzzles, the player has to figure out where to position each puzzle pieces based on the picture displayed on them and/or their unique shape. The displacement of the puzzle pieces is bounded by the edges of the reference picture and/or the edges of the mobile device screen. In other words, a puzzle piece in motion that is about to exit the visible limits of the screen will rebound on those edges and remain visible on screen.

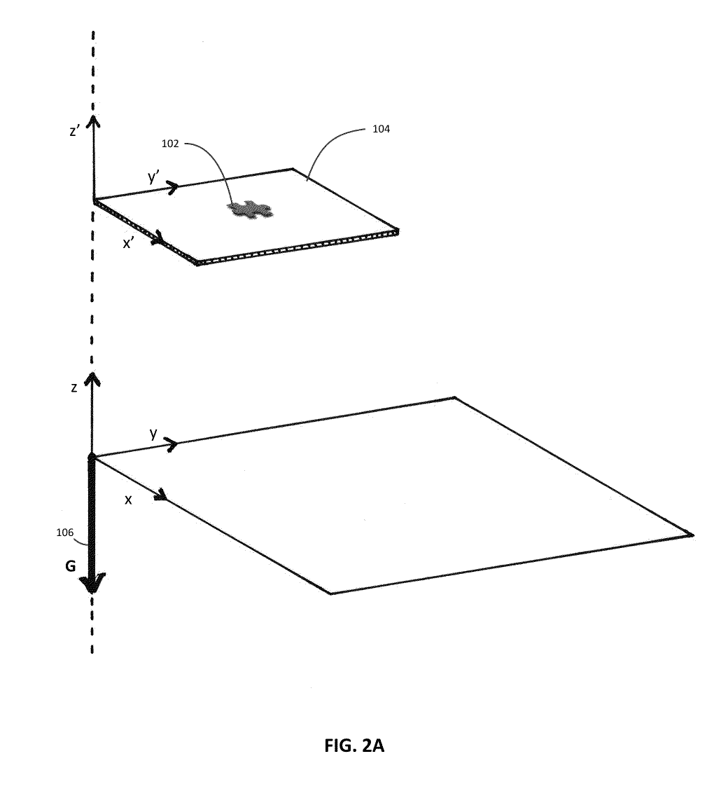

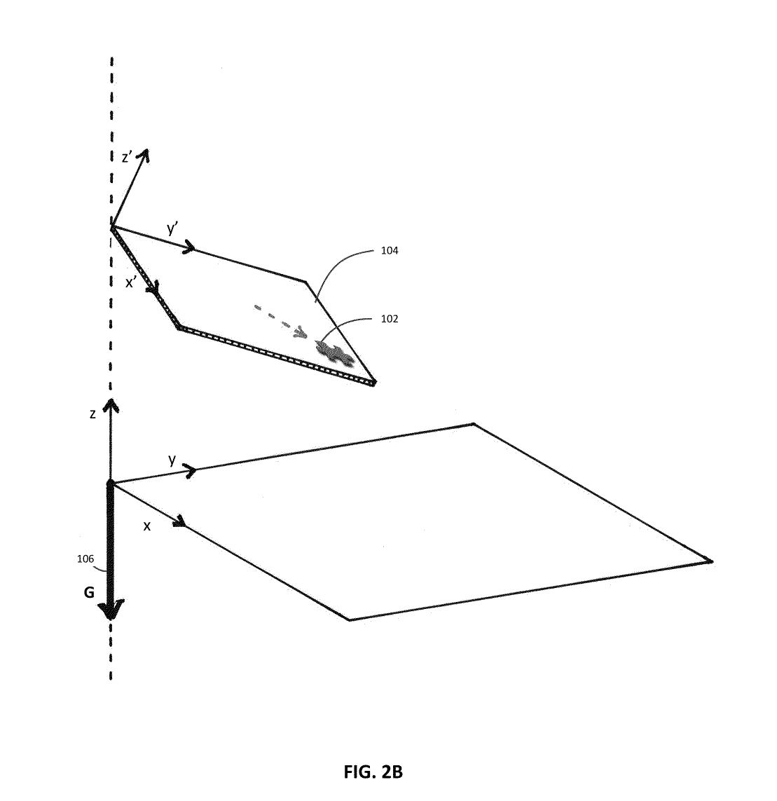

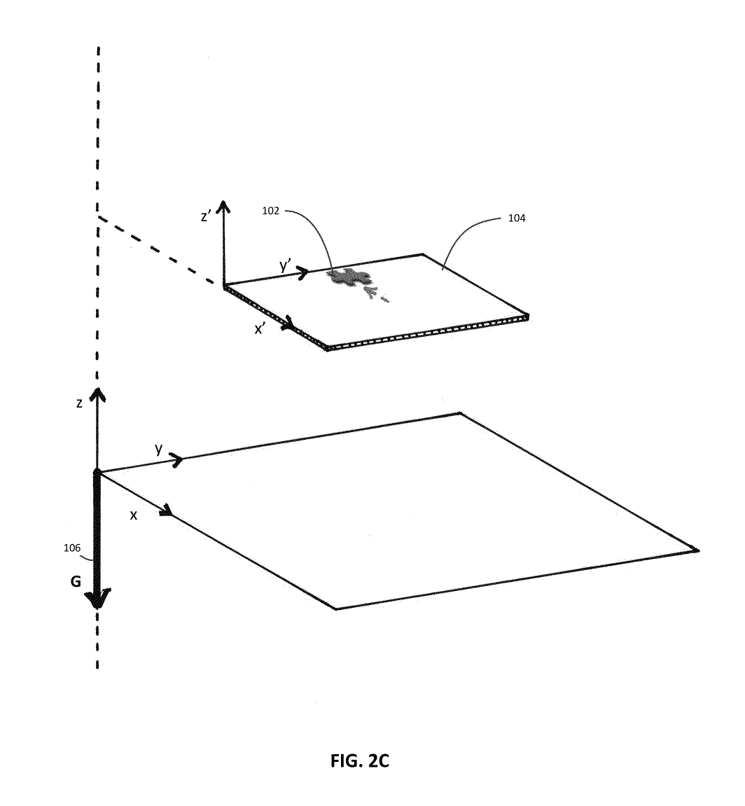

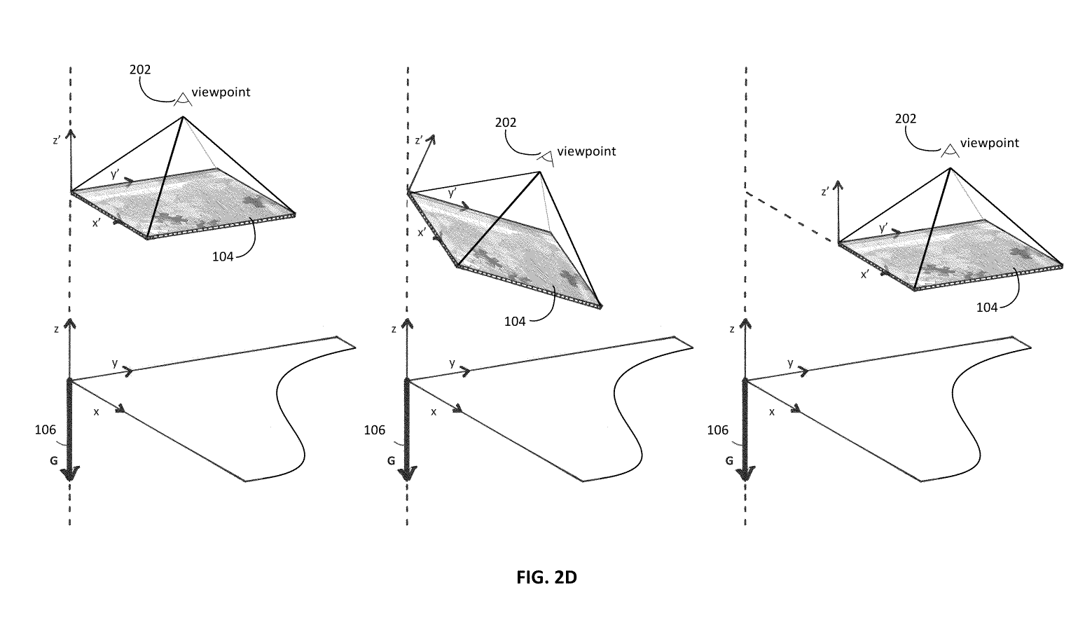

The motion of each puzzle pieces is commanded by the physic simulation. Each element of the simulation obeys to Newton's laws of motion The physical model used in this simulation is illustrated in FIGS. 2A to 2C. The three main constituent elements of that model are: one slippery surface 104, one or more puzzle pieces 102 resting over that slippery surface, and gravity 106. The coefficient of friction between the slippery surface and the puzzle pieces is set to be very low. Therefore, in situations where the plane of the slippery surface is not still and perpendicular to gravity then one can expect the puzzle pieces to slide down the slippery surface as they are pulled by the force of gravity. Such a situation is illustrated on FIG. 2B. In some embodiments, the puzzle pieces are also expected to be moving if the slippery surface is moved along the x′,y′ or z′ axis even if no rotation of the surface is happening as illustrated on FIG. 2C.

The three-dimensional position and orientation of the slippery surface in the simulation is driven by the motion sensors 502 of the mobile device. By making sure that the force of gravity in the simulation is always aligned with the force of gravity from the real world, which is an information derived from the motion sensors, the slippery surface position and orientation is driven by the system to always match precisely the mobile device screen position and orientation relatively to gravity in the real world. The image displayed on the mobile device screen (refer to FIGS. 1B and 2D) is the slippery surface 104 as seen from a viewpoint 202 from within the simulation and this viewpoint is fixed relatively to the slippery surface. From the user point of view, as he moves and rotates the screen in his hands, the motion of the puzzle pieces seem to be in reaction to a force of gravity aligned with the gravity he experiences in the real world. The player is fooled to think that the mobile device screen is the slippery surface and that the simulated gravity is aligned with real-world's gravity.

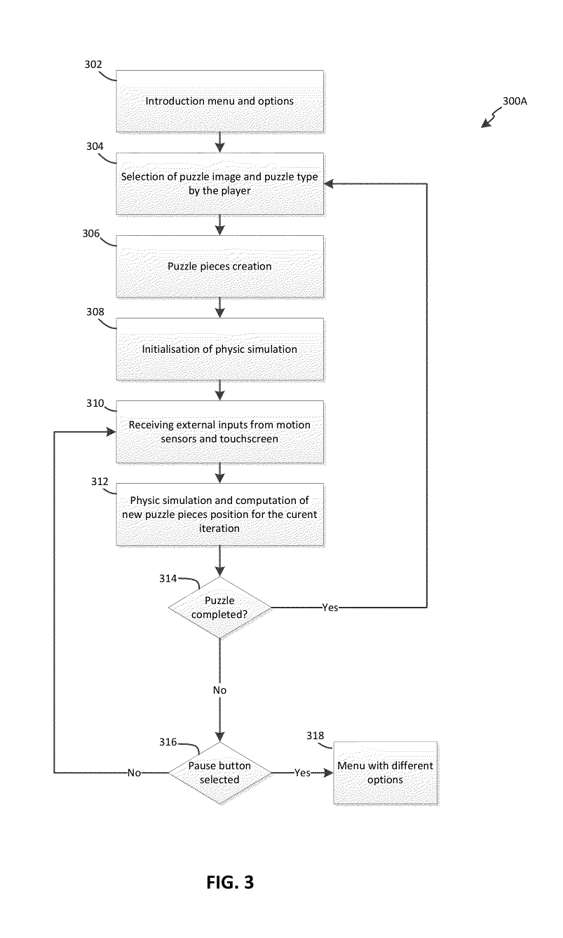

FIG. 3 depicts a flow chart illustrating an example process of providing a digital jigsaw puzzle game.

At block 302, the game provides instructions to the player such as how to select a puzzle picture, how to select a different type of puzzle (piece shape and number of pieces for the whole puzzle), how to adjust certain aspects of the gameplay, or how to adjust other options. Such options can be the choice of having a black-and-white or a color picture for the reference picture in background 104. To have or not an overlay of the puzzle pieces pattern over that background. It can be to select the number of moving puzzle pieces simultaneously present at all time during the game. It can be the option to play the game with the touch disabled using only the motion sensing to position the pieces, etc. The player sets the options with user interface elements such as buttons, radio buttons, on/off buttons, checkboxes, dropdowns and sliders.

At block 304, the player selects which picture and puzzle type he wants the puzzle to be generated from. That picture can be selected from various sources. It can be from a library of pictures already available within the game, from any personal picture libraries available on the player's mobile device, from a removable storage device 534 connected to the mobile device, directly from a camera 506 within the mobile device, from a public photo service feed available over the interact such as “Flickr” or “Pixable”, from a wifi connection or from any other kind of network connection 532 available to the mobile device.

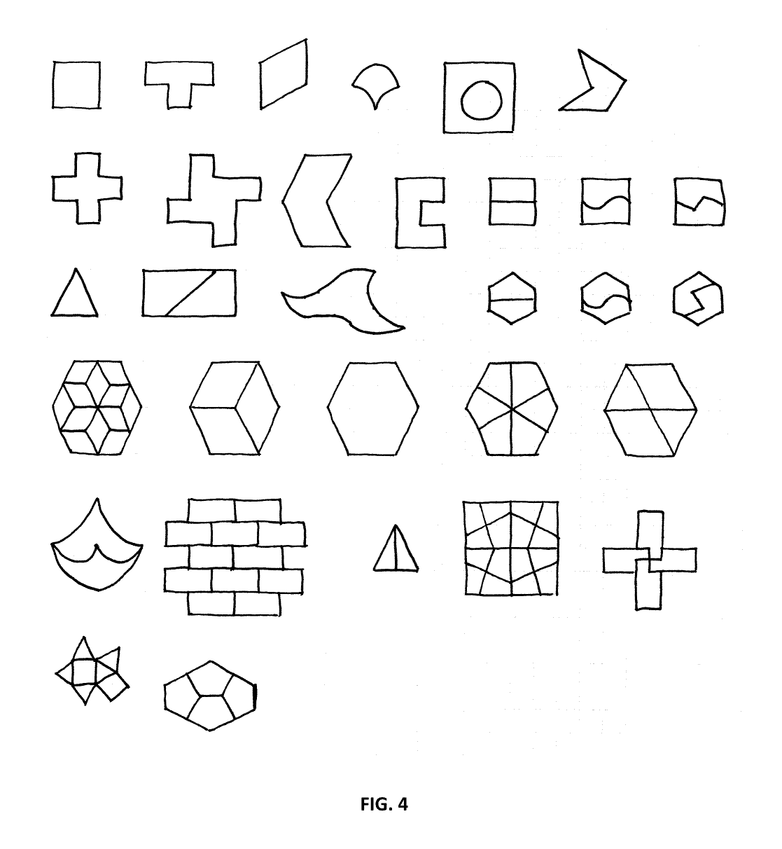

In some embodiments of the invention the player may select a puzzle piece shape that can be different from the traditional 2D puzzle piece shape pattern that everyone is familiar with. The puzzle pieces could have the shape of an hexagon, a square, a rectangle, the shape of a “+” sign, a triangle, or any other crazy shape as long as when assembled together the pieces form one single puzzle. FIG. 4 illustrates examples of such puzzle shapes that can be used in embodiments of the game. In other embodiments, the puzzle piece shape could be more elaborate 3D shapes such as a cube, a cuboid, a triangular based pyramid, a triangular prism or any other polyhedron or 3D shape that can form one single puzzle as welt. For one puzzle piece shape or pattern selected, the player could also select the number of pieces that constitute the whole puzzle. Typically the player has the choice between 3 or 4 number of pieces available although some embodiments could offer more variety.

At block 306, the game proceeds with the creation of the puzzle pieces based on the picture and puzzle type previously selected by the player. The whole picture is divided into multiple pieces according to a predefined pattern associated with the puzzle type selected. In some embodiments of the invention, a process of graphic editing and pixel adjustments is performed to provide an illusion of depth to the puzzle pieces. The objective being for the puzzle pieces to exhibit subtle bevels, shines and shadows around the edges in order to provide an illusion of thickness and 3D similar to the appearance of real jigsaw puzzle pieces. FIG. 1B shows 4 puzzle pieces that exhibit such special effects. This is an example of the kind a visual editing process that can be used in some embodiment of the invention in order to provide this 3D effect of the puzzle pieces been generated.

At block 308, all the parameters of initialization are set as the physic simulation starts. The physical parameters for each game elements such as gravity, mass, inertia, centroid, friction, damping and other coefficients or forces involved within the physic simulation have been previously set by the inventors to provide a fun, exciting and addictive gameplay. Some of those parameters may have been set or adjusted by the player at block 302 upon his personal preferences or skills.

At block 310, the mobile device 500A may include an accelerometer and/or a gyroscope and/or other motion sensors 502 that can provide the device inclination angle and any translation movements with respect to earth's gravitational force and transmit such information to the computing device 512 on which runs the game and the physic simulation. The mobile device may also include a touchscreen 504 that can provide one or many simultaneous touch events detected and transmitted to the physic simulation as well.

At block 312, the physic simulation is executed in order to calculate the new position for each puzzle pieces and/or for any other moving elements for the current cycle iteration. In order to do so, the simulation has first to evaluate all the forces applied on each individual constituent element present in the model. The forces considered by the simulation are the simulated gravity, the friction between each constituent element, the reaction forces between each of them, collision forces and other forces such as aerodynamic, hydrodynamic or field forces. Any touch detected over a puzzle piece or a moving game element is considered in the simulation to be a physical connection or an additional force applied to the element. One that is going to drive its motion in addition to all other forces applied on it. The physic simulation applies Newton's laws of motion and their derivatives to each element included in the model in order to compute the total force applied on each element relatively to theirs center of mass or centroid.

In embodiments of the invention the physic simulation also addresses collisions of the puzzle pieces between each other and/or with other static or animated game elements. Such a game element could be a static border aligned with the perimeter of the mobile device screen so that a puzzle piece moving toward the edges of the screen will rebound on them and remain visible within the boundary of the screen. The physic model could address collisions with friction at the impact point such as when two spinning puzzle pieces bump into each other and exchange some angular momentum.

Once the values of all the forces are found, the simulation applies Newton's second law of motion (F=ma) in either 2D or 3D coordinate systems in order to find the acceleration components of each constituent elements for which the mass is already known. Using the acceleration and information from the previous simulation cycle such as velocity and position the simulation can compute all the new puzzle pieces positions.

At this point, a logic within the simulation verifies if any puzzle pieces is now located in the vicinity of its final position. If the puzzle piece is within a certain threshold of distance and orientation of its final location, that puzzle piece is locked to its final position 108. It will remain at this location until further notice. The threshold of position and the threshold of orientation can be adjusted by the player has an option based on his preference or skill level.

At block 314, the system verifies if all puzzle pieces have been locked to their own final positions. If this is the case the puzzle is completed.

At block 316, if the puzzle is not completed, the system verifies if the pause button 110 has been pressed. If this is the case, the physic simulation is paused and at block 318 the player is offered a menu with options such as stop the game, return to block 302 (or 304) or resume the game.

Although some embodiments are shown to include certain features, the applicant(s) specifically contemplate that any feature disclosed herein may be used together or in combination with any other feature on any embodiment of the invention. It is also contemplated that any feature may be specifically excluded from any embodiment of an invention.

What is claimed is:

1. A system and method of providing a digital jigsaw puzzle game for mobile device that comprises a computer physic simulation in which: puzzle pieces are placed over a tilted surface displaying the picture of a jigsaw puzzle; the tilted surface position and orientation within the 3D space of the simulation are driven by the motion sensors inputs of the mobile device; each puzzle pieces are subject to gravity so that, as the user tilts the mobile device in a certain direction, the surface is tilted and the pieces slide down the surface in the corresponding direction; the motion of each puzzle pieces is computed using Newton's law of motion based on all external forces applied on each one of them; a puzzle piece moving close to its final position will be automatically placed and locked there; as the user moves the mobile device, he therefore controls the motions of the pieces over the picture displayed on the mobile device screen in order to complete the puzzle.

2. A system and method according to claim 1, wherein the image displayed on the mobile device screen correspond to a viewpoint from within the 3D simulation which is fixed relatively to the tilted surface, so that as the user moves the mobile device, and thus moves the surface within the simulation, the surface and its puzzle picture both appear fixed on the screen.

3. A system and method according to claim 1, wherein the external forces applied on a puzzle piece include a force of gravity that pulls the piece down the slope of the tilted surface and which, from the user point of view, is maintained parallel to the real world's gravity using inputs from the motion sensors from the mobile device.

4. A system and method according to claim 1, wherein the external forces applied on a puzzle piece include a force of reaction and a force of friction generated from the interaction of the puzzle piece with the tilted surface.

5. A system and method according to claim 1, wherein the external forces applied on a puzzle piece include forces of collision with other puzzle pieces that are meeting its path and which will modify its linear and angular momentum.

6. A system and method according to claim 1, wherein the external forces applied on a puzzle piece include hydrodynamic, aerodynamic or field forces.

7. A system and method according to claim 1, wherein the external forces applied on a puzzle piece include reaction forces from other objects such as boundaries fixed relatively to the tilted surface, delimiting the perimeter of the picture and that are keeping the puzzle pieces within the area of the picture as they rebound on them.

8. A system and method according to claim 1, wherein the external forces applied on a puzzle piece include a force driven by the touchscreen sensors inputs and which enable the user to move a puzzle piece around on the screen, following his finger, after he initially puts his finger on that puzzle piece.

9. A system and method according to claim 1, wherein the picture displayed on the tilted surface is the original picture used to generate the puzzle pieces so that the user can rely on it to help him identify where is the final position of each individual puzzle pieces.

10. A system and method according to claim 1, wherein the picture displayed on the tilted surface is a photographic modification of the original picture used to generate the puzzles, such as a black-and-white version, that still maintain enough resemblance with the original so that the user can still rely on this version to help him identify where is the final position of each individual puzzle pieces.

11. A system and method according to claim 1, wherein the picture displayed on the tilted surface includes a semi-transparent overlay pattern corresponding to the contour of the puzzle pieces shapes.

12. A system and method according to claim 1, wherein the puzzle pieces has the shape of a classical 2D puzzle piece.

13. A system and method according to claim 1, wherein the puzzle pieces can be of various shapes that are different from the classical puzzle shape such as the shape of a square, a triangle, a sphere, a polygon, a shape consisting of a curved line or any combinations of the above resulting in a new 2D shape.

14. A system and method according to claim 1, wherein the puzzle pieces has the 3D shape of a polyhedron.
